(19) United States
(12) Patent Application Publication
(10) Pub. No.: US 2022/0301092 A1
(43) Pub. Date: Sep. 22, 2022

(54) TRADING EXCHANGE FOR DECENTRALIZED AND CENTRALIZED SMART CONTRACTS FOR BETS USING CRYPTOCURRENCY OF UNEXPIRED SMART CONTRACTS

(71) Applicant: Rafael Groswirt, La Verne, CA (US)

(72) Inventor: Rafael Groswirt, La Verne, CA (US)

(73) Assignee: No Limit Technology Holdings, Inc., La Verne, CA (US)

(21) Appl. No.: 17/695,620

(22) Filed: Mar. 15, 2022

Related U.S. Application Data
(60) Provisional application No. 63/200,587, filed on Mar. 16, 2021.

(51) Int. Cl. G06Q 50/34; G06Q 40/04; G06Q 20/36; G06Q 20/38; G07F 17/32

(52) U.S. Cl. CPC G06Q 50/34; G06Q 40/04; G06Q 20/3678; G06Q 20/389; G07F 17/3288; G07F 17/3244

(57) ABSTRACT

A system for allowing trading of unexpired smart betting contracts using cryptocurrency for trading, comprising a computer and a crypto exchange application executing on the computer. The system creates a smart contract to host a bet between at least two betting devices, the bet associated with an ongoing event. The system also associates unexpired betting contracts provided by the devices with the smart contract, the unexpired contracts associated with the ongoing event. The system also enters funds associated with the bet into the smart contract, the funds received from electronic wallets of the betting devices. Upon conclusion of the event, the system also determines a result of the event, and disburses the funds to the betting device associated with the winning bet.

### CROSS REFERENCE TO RELATED APPLICATIONS

The present non-provisional patent application is related to U.S. Provisional Application No. 63/200,587 filed on Mar. 16, 2021, the contents of which are incorporated herein in their entirety.

### BACKGROUND

A hedge is a method to reduce risk and secure winnings for a specified bet. In sports, hedging comprises betting the opposite side of an original wager in order to either try to middle the game, or to reduce the downside exposure of the original wager.

A popular instance of hedging is futures betting. At the beginning of a sports season, a bettor may bet Team A at +2500 to win the championship at the conclusion of the season. In the example, Team A eventually does earn its way to the championship game and will face Team B in the game. Instead of riding out the +2500 and hoping Team A wins, the bettor could hedge the bettor's bet made at the season's outset and take the opposing team, Team B, to win on the moneyline.

While the bettor will receive more money if the bettor were to ride out the original bet, there is also more of a chance that the bettor come out with nothing. If the bettor hedges and bets Team B, the bettor will win something no matter the result of the game.

A breakdown of payouts in a possible hedge is as follows:
Original wager: $100 on Team A at +2500 for a $2,600 payout ($2,500 profit)
Hedge: $1,000 on Team B ML −150 for a $1,667 payout ($667 profit)
With Hedge:
   Team A wins: $2,600 payout−$1,000 bet−$100 bet=$1,500 profit
   Team B wins: $1,667 payout−$1,000 bet−$100 bet=$567 profit
Without Hedge:
   Team A wins: $2,500 profit
   Team B wins without hedge: down $100

As is demonstrated above, with a hedge the bettor realizes a positive outcome no matter how the game goes. Without the hedge, the bettor wins a bit more after a Team A win but also comes out negative if Team B wins as a favorite.

As to whether a bettor should hedge, hedging a wager comes down to personal preference. Some bettors are satisfied with a positive payout and prefer not to risk everything, which is when a hedge makes sense. For bettors who have confidence in their original wager and accept the risk of losing money if the opposing side wins, there is no reason to hedge.

Hedging can be done with many kinds of bets. Futures bets may be the most popular instance to hedge, but as sports betting grows, in-play wagering is also at an all-time high. If a bet does not look favorable halfway through a game, hedging with an in-play bet could be done. In this case, it's important to note all possibilities in a game because if a bettor makes the wrong hedge, he/she may be out two bets if something truly unforeseen happens.

For example, in American football, a bettor bets Team A −7 to beat Team B. But Team A begins the second quarter losing 14-0. Since it appears that Team B will win, the bettor decides to hedge the Team B moneyline at −150. Unfortunately, as the game continues, Team B weakens and loses its lead and Team A eventually wins in the game's late stages, meaning both of the bettor's bets lose. If the bettor wants to hedge in-game, it is best for the bettor to be making educated and well considered decisions instead of blindly betting the opposite side.

Another possible hedge method is in a parlay. Luckily, these are a little more straightforward than an in-game hedge. The easiest example is if a bettor's first two bets win in a three-team parlay. If the bettor wants to guarantee winnings, the bettor simply hedges by betting the opposite side in the third bet of the parlay. The bettor will guarantee winnings, though the payout will be smaller.

### BRIEF DESCRIPTION OF THE FIGURE

FIG. 1 is a block diagram of a system of allowing trading of unexpired smart betting contracts using cryptocurrency for trading according to an embodiment of the present disclosure.

### DETAILED DESCRIPTION

Systems and methods provided herein allow trading of unexpired sports or eSport smart betting contracts between two or more parties using cryptocurrency for trading purposes. Betting contracts not related to sports may also be traded.

A system for allowing trading of unexpired smart betting contracts using cryptocurrency for trading is provided. A crypto exchange may be hosted on a computer, on a mobile device such as a cell phone, or on a tablet device. The computer starts a new smart contract to host a bet between at least two sports betting devices. The crypto exchange associates unexpired betting contracts provided by the devices with the smart contract. The unexpired contracts are associated with the ongoing event. The system enters funds associated with the bet into the smart contract, the funds received from electronic wallets of the betting devices. Upon conclusion of the event, the crypto exchange determines a result of the event. The crypto exchange disburses the funds to the betting device and associated account associated with the winning bet.

The unexpired sports betting contracts allow bettors to hedge their positions. The crypto exchange is a centralized exchange or a decentralize exchange. Trading may take place until the last second of a sports contest that is the subject of a bet. A seller may sell part or all of a contract such that the system supports a one-to-many model of selling and buying. Electronic wallets held by betting devices are decentralized wallets. Funds only move to the smart contract during a bet and return to the wallets once the bet is over. The crypto exchange application uses at least blockchain data to determine the result of the event. Contracts can be on and off chain related to trading.

A method for trading smart contracts for betting with cryptocurrency is also provided. The method comprises a computer hosting an exchange acting as a crypto exchange, the computer receiving a request to host a bet from at least a first bettor device, the bet based on use of at least one unexpired sports contract. The computer may be a mobile device such as a cell phone, or on a tablet device. The method also comprises the computer receiving a message from at least a second bettor device, the second bettor device indicating an intention to participate in the bet. The method also comprises the computer starting a smart contract to host the bet.

The method also comprises the computer inserting funds into the smart contract received from electronic wallets of at least one of the first and second bettor device, the funds supporting terms of the bet. On occurrence of an event upon which the bet is predicated and wherein a final result of the bet is thereby determinable, the method also comprises the computer determining the final result and determining a winner of the bet, the winner comprising one of the first and second bettor devices. The method also comprises the computer causing the smart contract to release funds to the winner in accordance with the terms of the bet. The method also comprises the computer using blockchain to support determination of the result. The exchange is one of a centralized crypto exchange and a decentralized crypto exchange. The method also comprises the bettor devices using unexpired betting contracts to hedge their positions

A method for allowing trading of unexpired smart betting contracts using cryptocurrency for trading is also provided. The method comprises a computer hosting a crypto exchange application creating a smart contract to host a bet between at least two betting devices, the bet associated with an ongoing event. The method also comprises the computer associating unexpired betting contracts provided by the devices with the smart contract, the unexpired contracts associated with the ongoing event,

The method also comprises the computer entering funds associated with the bet into the smart contract, the funds received from electronic wallets of the betting devices. The method also comprises the computer, upon conclusion of the event, determining a result of the event and disbursing the funds to the betting device associated with the winning bet.

An exchange will act as a crypto exchange or decentralized crypto exchange such as UniSwap or PanCakeSwap decentralized exchanges and mimic a crypto exchange but may use unexpired sports betting contracts to allow bettors to hedge their positions. Funds are generally not held by a central entity. Custodial models are also provided for herein. A betting protocol in a given instance may involve from two to many as participants in an insurable smart contract that will conclude with the conclusion of a bet. The system may use blockchain data like Chainlink to determine the correct result so the smart contract can award a winner.

UniSwap, PanCakeSwap, and Chainlink may be proprietary systems not provided by systems and methods provided herein. In embodiments, implementations may use systems provided by other vendors.

Uniswap is a decentralized finance protocol that is used to exchange cryptocurrencies. The protocol facilitates automated transactions between cryptocurrency tokens on the Ethereum blockchain through the use of smart contracts. Uniswap generates fees daily for the liquidity providers who facilitate liquid markets for the cryptocurrencies being exchanged.

Uniswap is provided on blockchain networks that are decentralized and running open-source software, as opposed to any centralized intermediary. This is in contrast to cryptocurrency exchanges that are run by centralized companies such as Coinbase, Binance and OKEx.

Uniswap uses liquidity pools rather than serving as market maker, also in contrast to centralized exchanges, with an aim to create more efficient markets. Individuals and bots that may referred to as “liquidity providers” provide liquidity to the exchange by adding a pair of tokens to a smart contract which can be bought and sold by other users. In return, liquidity providers are given a percentage of the trading fees earned for that trading pair.

PancakeSwap is a popular decentralized exchange (DEX) on Binance Smart Chain (BSC). PancakeSwap features significant liquidity, wide-ranging feature set, and sizeable user base. PancakeSwap is designed to allow users to securely trade Binance Coin (BNB) and a variety of BEP-20 tokens without relying on centralized services or losing control over their private keys. As a decentralized exchange, trades on PancakeSwap are executed via smart contracts, a practice that may eliminate counterparty risks.

ChainLink aims to incentivize data providers or oracles to supply external information to smart contracts running on blockchain networks. Smart contracts are embedded codes that enable automated execution when certain conditions are met. For smart contracts to function in an automated manner, they require oracles to supply data in order for them to execute events. With the growing popularity of DeFi protocols, the need for off-chain data that supply the required information to smart contracts became even more evident.

ChainLink acts as a bridge between data sources and smart contract networks, to further enable a smart contract to execute based on a reliable source of information. Oracles within the Chainlink network are incentivized to provide accurate data, since a reputation score is assigned to each. Moreover, the network is incentivized through its native token, which is awarded to the nodes in exchange for supplying reliable information to smart contracts.

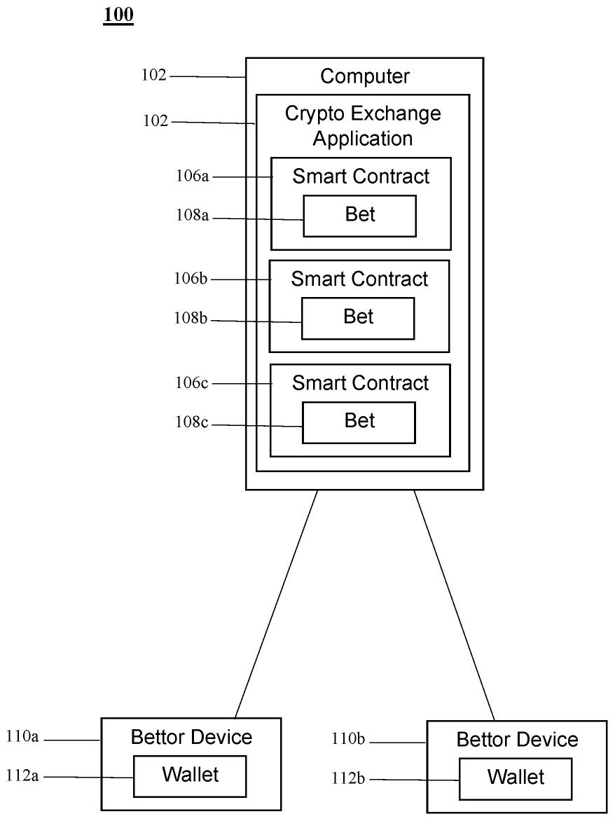

Turning to the FIGURE, FIG. 1 is a block diagram of a system of allowing trading of unexpired smart betting contracts using cryptocurrency for trading according to an embodiment of the present disclosure. FIG. 1 illustrates components and interactions of a system 100 of allowing such trading.

The system 100 comprises a computer 102 which, as noted, may be a conventional computer but may also be a mobile device such as a cell phone or may be a tablet device.

The system 100 also comprises a crypto exchange application 102, smart contracts 104a-c, and bets 106a-c. The system also comprises bettor devices 108a-b and wallets 108a-b.

What is claimed is:

1. A system for allowing trading of unexpired smart betting contracts using cryptocurrency for trading, comprising:
a computer; and
a crypto exchange application executing on the computer that:
creates a smart contract to host a bet between at least two betting devices, the bet associated with an ongoing event,
associates unexpired betting contracts provided by the devices with the smart contract, the unexpired contracts associated with the ongoing event,
enters funds associated with the bet into the smart contract, the funds received from electronic wallets of the betting devices,
upon conclusion of the event, determines a result of the event, and
disburses the funds to the betting device associated with the winning bet.

2. The system of claim 1, wherein the unexpired betting contracts are for Sports or eSport smart betting contracts or for contracts unrelated to sports.

3. The system of claim 1, wherein the unexpired betting contracts allow bettor accounts associated with bettors to hedge their positions.

4. The system of claim 1, wherein the crypto exchange is centralized or decentralized exchanges and wherein trading takes place until the last second of the sports contest.

5. The system of claim 1, wherein a seller sells part or all of a contract such that the system supports a one-to-many model of selling and buying.

6. The system of claim 1, wherein the electronic wallets are decentralized wallets and wherein funds only move to the smart contract during a bet.

7. The system of claim 1, wherein the crypto exchange application uses at least blockchain data to determine the result of the event.

8. The system of claim 1, wherein contracts are one of on and off chain related to trading.

9. A method for trading smart contracts for betting with cryptocurrency, comprising:
a computer hosting an exchange acting as a crypto exchange, the computer receiving a request to host a bet from at least a first bettor device, the bet based on use of at least one unexpired sports contract;
the computer receiving a message from at least a second bettor device, the second bettor device indicating an intention to participate in the bet;
the computer starting a smart contract to host the bet;
the computer inserting funds into the smart contract received from electronic wallets of at least one of the first and second bettor device, the funds support terms of the bet;
on occurrence of an event upon which the bet is predicated and wherein a final result of the bet is thereby determinable, the computer determining the final result and determining a winner of the bet, the winner comprising one of the first and second bettor devices, and
the computer causing the smart contract to release funds to the winner in accordance with the terms of the bet.

10. The method of claim 9, further comprising the computer using blockchain to support determination of the result.

11. The method of claim 9, wherein the exchange is one of a centralized crypto exchange and a decentralized crypto exchange.

12. The method of claim 9, further comprising the bettor devices using unexpired betting contracts to hedge their positions

13. The method of claim 9, wherein the unexpired betting contracts are for Sports or eSport smart betting contracts or for contracts unrelated to sports.

14. A method for allowing trading of unexpired smart betting contracts using cryptocurrency for trading, comprising:
a computer hosting a crypto exchange application creating a smart contract to host a bet between at least two betting devices, the bet associated with an ongoing event;
the computer associating unexpired betting contracts provided by the devices with the smart contract, the unexpired contracts associated with the ongoing event;
the computer entering funds associated with the bet into the smart contract, the funds received from electronic wallets of the betting devices;
the computer, upon conclusion of the event, determining a result of the event, and
the computer disbursing the funds to the betting device associated with the winning bet.

15. The method of claim 14, wherein the unexpired betting contracts are for Sports or eSport smart betting contracts or for contracts unrelated to sports.

16. The method of claim 14, wherein the unexpired betting contracts allow bettor accounts associated with bettors and betting devices to hedge their positions.

17. The method of claim 14, wherein the crypto exchange is centralized or decentralized exchanges and wherein trading takes place until the last second of the sports contest.

18. The method of claim 14, further comprising a betting device associated with a seller selling at least part of a contract such that a one-to-many model of selling and buying is supported

19. The method of claim 14, wherein the electronic wallets are decentralized wallets and wherein funds only move to the smart contract during a bet.

20. The method of claim 14, further comprising the computer, via the crypto exchange application, using at least blockchain data to determine the result of the event.
